(19) United States
(12) Patent Application Publication
(10) Pub. No.: US 2003/0088519 A1
(43) Pub. Date: May 8, 2003

(54) Email pet registration

(76) Inventors: Shelly L. Woodson, Glendora, CA (US); Christy M. Murphy, Glendora, CA (US)

Correspondence Address: RICK MARTIN, PATENT LAW OFFICES OF RICK MARTIN, PC, 416 COFFMAN STREET, LONGMONT, CO, 80501, US

(21) Appl. No.: 10/289,848

(22) Filed: Nov. 7, 2002

Related U.S. Application Data
(60) Provisional application No. 60/348,724, filed on Nov. 7, 2001.

(51) Int. Cl. G06F 17/60

(52) U.S. Cl. 705/64; 340/573.3; 340/573.4

(57) ABSTRACT

An email identification address is affixed to a collar or bracelet. The invention includes the process of registration of said email identification address on a database at a web site. The email identification address can be registered for animals, toddlers, or handicapped individuals allowing finders to contact the owner(s), emergency contact individual, veterinarian or doctor, all automatically by sending one simple email message. A 1-800# number is also provided for finders who do not have email access to enter the identity of the lost pet by voice.

### CROSS-REFERENCE TO RELATED APPLICATION

This application is a non-provisional application claiming the benefits of provisional application No. 60/348,742 filed Nov. 7, 2001.

### FIELD OF THE INVENTION

The present invention relates to a process of registering pets with an email address and allowing finders of lost pet(s) to easily contact the owner(s). The invention provides a method to register pets via a registered pet collar with a-specific email address for the pet. It also would have a tag with a 1-800-xxx-xxxx phone number for finders who do not have email access.

### BACKGROUND OF THE INVENTION

Lost pets usually result in an increase to the pet owner(s) stress level. Once an animal is lost, the owners have limited resources at their disposal. Phone calls to neighbors, traveling about the last vicinity in which the pet was seen, traveling about the local neighborhood, and finally a call to the local dog warden. Pets found by the local animal control departments usually result in costs to the owner for retrieval. When animals tend to wander far from home, or are lost at a location far from home, the timeframe of getting the animal back to the owner can entail several days to several weeks. Internal semiconductor identification chips require a veterinarian procedure and can only be scanned if the finder brings an animal to a shelter or clinic where a scanner is available. There are various manufacturers of identification chips. Although there are scanners that are supposed to read chips from various manufacturers, a special scanner may be required to read certain chips for proper animal identification. Finders have to transport the found animal to a veterinarian, shelter, etc. for scanning. This can be a major source of inconvenience and time lost to the finder. Finders also may not be aware of the chip identification systems. Veterinarians, animal shelters, etc. may not have proper scanners at their facility. Owners may not want to subject their animal to a chip implant procedure. Local license tags are not always kept up to date on an animal. If people relocate they may not update their license tags prior to the animal being lost.

Found animals may be in a state of trauma or in an injured condition, in which case a direct contact to the animal's veterinarian is not always available.

What is needed is a method for a lost animal to be retrieved by the owner(s) as soon as possible after it is found. What is also needed is a way to have direct contact with a veterinarian in the event a found animal is found in a state of injury or trauma. The present invention resolves this problem and expands a registration email system to be able to include not only pets but also other animals, toddlers, handicapped people, items of value, etc.

### SUMMARY OF THE INVENTION

The main aspect of the present invention is a registration method whereby an animal (toddler, handicapped individual, valuable item) has an email address on its neck collar or an attached tag to enable the finder of a lost animal fast and efficient contact with the owner once a lost animal is found.

Another aspect of the present invention is to provide a 1-800# phone number in the event a finder does not have email access.

Another aspect of the present invention is to provide a means for an emergency back-up contact(s) should the owner not be available.

Another aspect of the present invention is to provide a means to contact the animal's veterinarian in the event the animal requires medical assistance when found.

Another aspect of the present invention is to provide anonymity of the owner if desired by providing a means for the owner to contact the finder.

Another aspect of the present invention is to provide a database of information on the owner, veterinarian, emergency contact(s), animal description, animal name, owner desire for anonymity or direct contact.

Another aspect of the present invention is for use with registration of a human, such as a toddler or mentally handicapped individual, in case of a person being lost.

Another aspect of the present invention is to provide for an allowance of a reward option by the owner, veterinarian, or emergency contact.

Another aspect of the present invention is for use with an article of value for email ID registration.

Other aspects of this invention will appear from the following description and appended claims, reference being made to the accompanying drawings forming a part of this specification wherein like reference characters designate corresponding parts in the several views.

Lost animals are major sources of owner stress levels. The present invention provides a universal means of using email and the web as a quick and efficient method of animal retrieval in the case of a lost animal. The present invention is useful for pets, such as cats, dogs, etc. and other animals such as farm animals, wildlife conservation animals etc. to be readily retrieved by the owner(s) or care providers when found. The present invention can also be used for toddlers or mentally handicapped individuals who may get lost by wearing of a bracelet or neck email address ID tag. The present invention can also be used to register an item of value should it get lost.

An email address ID is provided with each purchase. The preferred embodiment of the present invention is to have an email ID address embedded directly on a neck collar (embroidered, stamped, metal tagged, burned into leather, etc.) along with a 1-800# affixed to an attached tag. The 1-800# is for cases in which the finder does not have email access. The preferred embodiment of the present invention applies to registering animals or pets although it can be used for applications with toddlers, handicapped person(s) or items of value.

An alternate embodiment of the present invention would be to provide the email ID address and backup 1-800# on a metal or plastic tag attached to a collar, bracelet, ear tag, etc.

Another alternate embodiment of the present invention would be to have the email address and the 1-800# embedded directly on the neck collar, bracelet, or ear tag. Any combinations of the above can also be used.

The owner would procure an email address collar, tag or combination of both, offered by the central service provider.

Procurement could be via the central service provider web site, a commercial or pet store, a veterinary office, or other point of sale, etc. In the case a wristband is required for a toddler or handicapped person, procurement may include a doctor or agency as well as commercial stores or other point of sale, etc. Custom collars and/or tags could also be ordered from the central service provider web site or through a 1-800#. Collars would come in various sizes, colors and color combinations to meet size requirements and owner preferences.

Once the purchased email address (collar, tag or combination) is obtained, the owner would register the email address on-line at the central service provider website or via the central service provider 1-800#. The process of registration would require the owner to input information such as the following items:

a) Owner name

b) Owner address

c) Owner phone number(s)—home, office, etc.

d) Owner email address

e) Emergency contact number(s)

f) Veterinary (or doctor) contact number(s)

g) Pet name, description

h) Anonymity of owner wanted or not wanted

i) Email address registered

j) Reward information if applicable

k) Other fields expandable as required

All registered data would enter the central service provider universal database. Confirmation back to the owner would be direct if registered by 1-800# or by email if registered on the website. Initial email procurement would include a registration fee and registration of an initial time period (such as one year). Registration update fees would start after the initial registration period elapses. Registration updates could be done via the central service provider web site or via the 1-800#.

The registration process also allows the owner to pre-post an award for a found animal (toddler, handicapped individual, article). The reward may also be from a veterinarian, such as a free animal checkup for a finder's pet, which would give the veterinarian a possibility to generate a new customer business.

As mentioned above, the present invention can also be used to register toddlers, handicapped individuals or articles of value.

Once an animal (toddler, handicapped individual, or article) is found, the finder can simply send an email to the email address on the collar (bracelet or tag) such as “fido@Lapaw.com”. Or, when the finder does not have email access, a 1-800# is provided for the finder to call. When an email is sent to the email ID address (i.e. fido@Lapaw.com), the database is automatically queried for owner information (manually, in the event the finder uses the 1-800#). The finder is then sent an email with all pertinent phones and other information (pet name, owner phone, emergency contact, veterinarian/doctor contact, reward, etc.) in a timely manner. If the finder uses the 1-800#, the information is queried from the database by a representative of the central service provider and information is passed onto the finder by phone. In the event that the owner had elected to remain anonymous, the finder would be told (email or phone) that the owner or owner representative would contact he/she in the immediate future. Then, the owner or owner representative would be immediately contacted and given the finder contact information.

### BRIEF DESCRIPTION OF THE DRAWINGS

FIG. 1A is a flow chart of the registration process.

FIG. 1B is a flow chart of the process for a lost pet that is found.

FIG. 2 is a depiction of a collar or wristband with embedded email address identification and also shows an alternate tag email ID address.

FIG. 3 is a flow chart showing the registration or universal database at the central service provider web site.

Before explaining the disclosed embodiment of the present invention in detail, it is to be understood that the invention is not limited in its application to the details of the particular arrangement shown, since the invention is capable of other embodiments. Also, the terminology used herein is for the purpose of description and not of limitation.

### DETAILED DESCRIPTION OF DRAWINGS

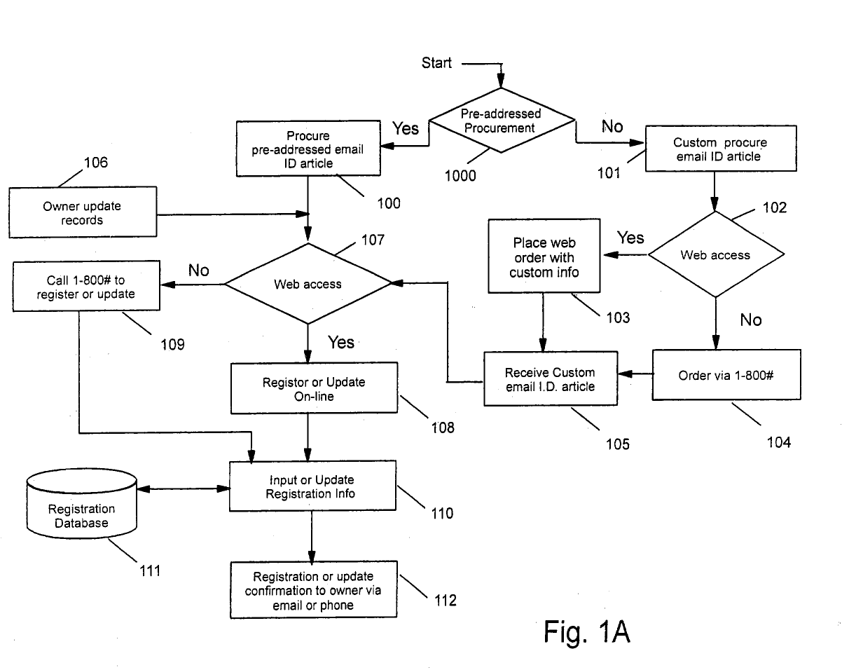

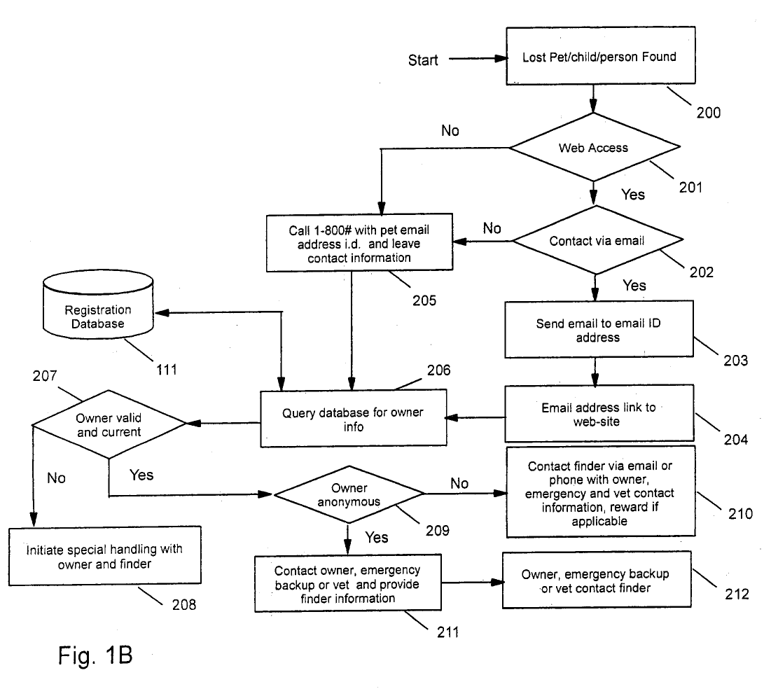

FIG. 1A is a flow chart of the registration process. The procurement process starts with a decision to procure a pre-addressed email ID article (collar, wristband, or necklace) (1000). Or, it may be desired to procure a custom email ID article (101), that is, have a custom name for the email ID address.

If a custom email ID (101) is selected, the buyer can decide to use web access (102). If the web access method were chosen, the buyer would place a custom order on the web (103). If a desired custom name had been previously used, the central service provider would offer an email ID name with a numeral extension affixed such as “name2@site.com”. If the buyer chose not to use web access, the custom buyer would call an order via a 1-800# (104). Once an email ID article (collar, bracelet, necklace) has been received (105), a determination by the owner is made to register via web access or phone (107). If a phone is used to register via the 1-800# (109), the information is collected and stored/updated (110) and then placed into a registration database (111). If web access is chosen (107), the information is inputted directly by the owner on-line (108). Registration information would include, but is not limited to:

a) Owner name

b) Owner address

c) Owner phone number(s)—home, office, etc.

d) Owner email address

e) Emergency contact number(s)

f) Veterinary (or doctor) contact number(s)

g) Pet name, description

h) Anonymity of owner wanted or not wanted

i) Email address registered

j) Reward information if applicable

k) Other fields expandable as required

Once information is collected (108), the registration information is sent to a registration database (111) where it resides as a permanent record.

The custom order process could also have an automatic registration whereby formal registration (108) would be done at the time of the custom order is placed on the website (103) or the custom order is placed by phone (104) depending on the buyer preferences and information available at that time.

If pre-addressed procurement were selected (1000), the owner would procure the pre-addressed ID article (100) at a point of sale (commercial store, veterinary office, medical office/supply store, etc.). A decision to use web access is then made (107). If no web access is available or if the owner prefers phone registration, registration is made by calling a 1-800# (109). All registration information as discussed above would be collected or updated (110) and then stored into a registration database (111). Confirmation is then either given by phone or emailed to the owner (112).

Owner updates (106) can be done by web access or phone. A determination to use web access (107) is made. If web access is used, the owner updates pertinent changes in information on-line (108). If phone is used, the owner updates pertinent changes by calling the 1-800# (109). Once again, all information on updates is collected (110) and then stored in the registration database (111). Confirmation of updated information is then either given by phone or emailed to the owner (112).

FIG. 1B is a flow chart of the process for a lost animal (child or person or item) that is found (200). If the finder has web access (201), the finder can contact the central service provider via email (202). If the finder does not have web access or does not want to utilize web access, the finder can call the 1-800# and provide the email ID address by phone (205).

If the finder elects to send email to the email ID address (203), the email is linked to the website (204) of the central service provider.

Once the contact is made by the 1-800# (205) or by email ID address link (204), a query is made for owner information (206) in the registration database (111). A determination is made to verify if the owner is valid and current (207). If the owner is valid and current (207), a query is made to see whether or not the owner had wished to remain anonymous (209) as part of the registration process. If the owner did not require remaining anonymous (209), the finder is contacted via email or phone and given owner information and emergency and vet contact information (210) as required. If the owner did require remaining anonymous (209), the owner, emergency backup or vet is contacted and is provided with finder information (211). The owner, emergency contact or vet will then contact the finder directly (212).

In the event that the owner is either not valid or is not current, special handling is initiated (208) which would have manual intervention for the finder and owner to insure proper resolution.

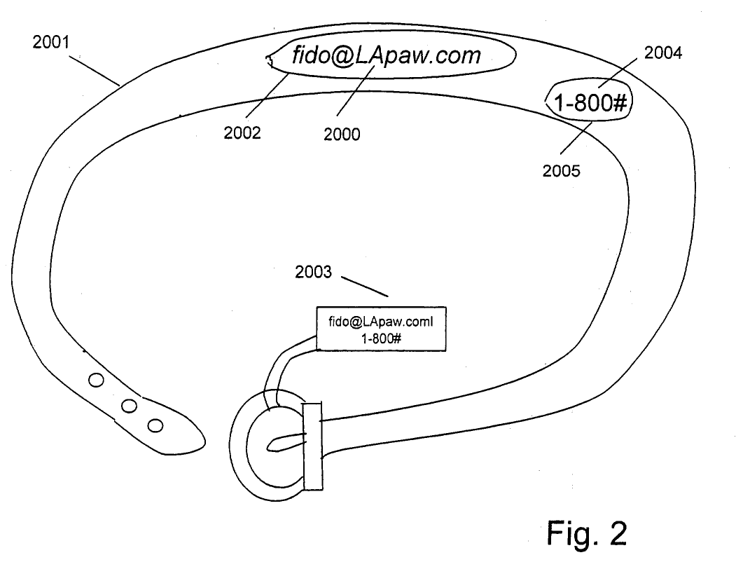

FIG. 2 is a depiction of a collar (or bracelet) 2001 with embedded email ID address “Fido@Lapaw.com” 2000 and also shows an alternate plastic or metal tag with the email ID address 2003. The email ID address 2000 can be embedded directly onto a neck collar or bracelet 2001 (embroidered, stamped, burned into leather, etc.). The ID address “Fido@Lapaw.com” 2000 can alternately be affixed to the collar/bracelet 2001 via a metal/plastic tag 2002. The 1-800# 2004 can likewise be embedded directly onto a neck collar (or bracelet) 2001 (embroidered, stamped, burned into leather, etc.) or alternately be affixed to the collar/bracelet via a metal/plastic tag 2005.

Another alternative is to put the email ID address on a metal or plastic tag 2003 which would attach to the collar/bracelet 2001. The tag 2003 would contain the email address and the 1-800#.

FIG. 2 depicts both the email ID address “Fido@Lapaw.com” 2000 and 1-800# 2004 embedded/attached directly on the collar/bracelet 2001 and also on a separate tag 2003 attached to the collar/bracelet 2001 with the same information. Although two alternatives are shown, only one is required. Also, various combinations of the email ID address and 1-800# could be used. For example the email ID address “Fido@Lapaw.com” 2000 could be on the collar/bracelet 2001 and the 1-800# could be on an affixed tag 2003.

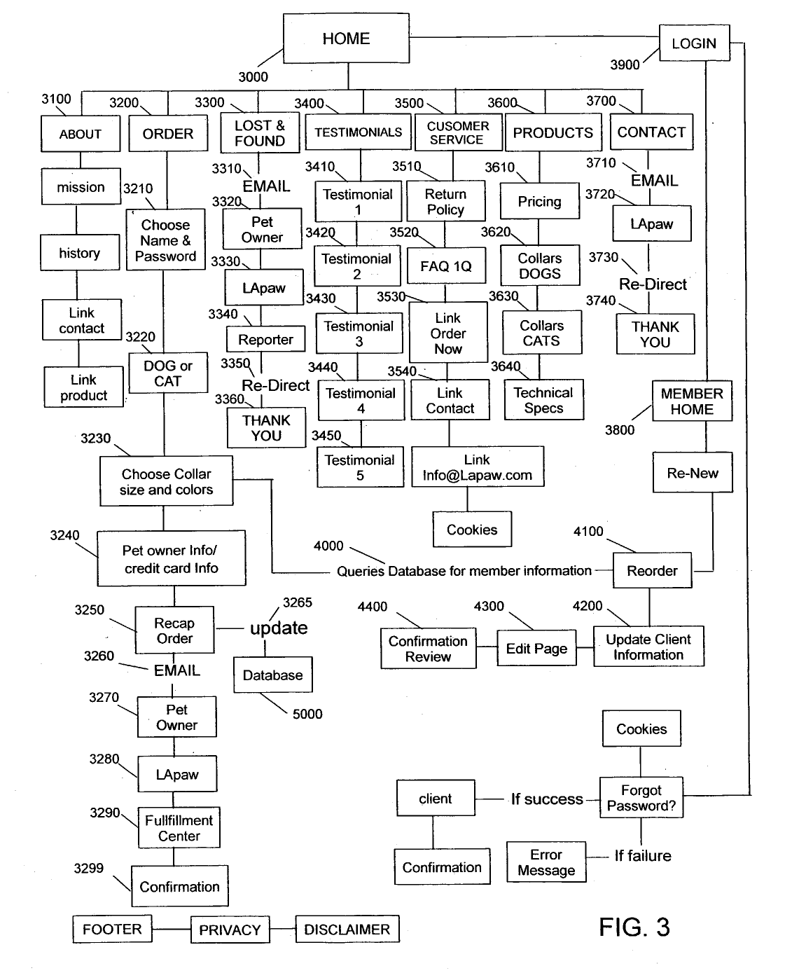

FIG. 3 is a flow chart showing the registration or universal database 5000 at the central service provider web site home page 3000. When navigating the web site home page 3000 a client or user may review the following web site links: About LApaw 3100; How To Order 3200; Lost & Found Pets 3300; Testimonials 3400; Customer Service 3500; Products To Protect Your Pet 3600; Contact LApaw 3700. Client members can access Member Home 3800 by accessing the login link 3900.

To procure products from the central service provider web site home page 3000, a client or user accesses the Products To Protect Your Pet 3600 link to review pricing 3610 of available dog collars 3620 and cat collars 3630. A client or user may also review the technical specifications 3640 of available dog collars 3620 and cat collars 3630.

In addition, a client or user may access the Order link 3200 to order products from the central service provider web site home page 3000. There, a client or user can choose name and password 3210 for a specified dog or cat 3220. A client or user then designates his or her choice of color and size of pet collar 3230 before inputting purchaser/payment information and/or pet owner information 3240. The client or user is able to review inputted data (name and password 3210, specified dog or cat 3220, choice of color and size of pet collar 3230, purchaser/payment information and/or pet owner information 3240) when the order information is recapped 3250. An email message 3260 is sent to the client or user or pet owner 3270 to confirm the order 3299 and then to LApaw 3280 where the order is fulfilled 3290. In addition, when the order is recapped 3250, the universal database 5000 is updated 3265.

When a client or user designates his or her choice of color and size of pet collar 3230, the database 5000 is queried for member information that may have been previously inputted 4000. If the database 5000 contains previously inputted member information 4000, the client or user is deemed to be a return client and the order is deemed to be a reorder 4100. The return client may then update his or her information 4200 and/or edit the information 4300 before receiving a confirmation page for review 4400.

A client or user is able to contact LApaw 3720 by sending an email 3710 at the Contact link 3700. The email triggers a redirect link 3730 to send a thank you and/or confirmation of receipt 3740 message to the client or user from the central service provider web site home page 3000.

When a client or user accesses Customer Service 3500, he or she is able to review the LApaw return policy 3510 and Frequently Asked Questions 3520. The client or user is also able to link to the order process 3530 or to review contact information 3540. A user may also send an email message is sent to info@Lapaw.com 3550.

To access the Lost & Found Pets link 3300, a finder or user enters the email ID address 3310 found on a lost/stolen pet's tag. An email message to sent to the pet owner 3320, to LApaw 3330, and to a reporter 3340. The finder or user email triggers a redirect link 3350 to send a thank you and/or confirmation of receipt 3360 message to the finder or user from the central service provider web site home page 3000.

A client or user is also able to review Testimonials 3400 from clients or users (for example, 3410, 3420, 3430, 3440, 3450).

Although the present invention has been described with reference to preferred embodiments, numerous modifications and variations can be made and still the result will come within the scope of the invention. No limitation with respect to the specific embodiments disclosed herein is intended or should be inferred.

We claim:

1. An animal registration system comprising:
a tag for a neck or a limb;
said tag having an email address affixed thereon;
wherein said email address is identifiable with a specific animal; and
wherein a finder of the animal can contact a pre-assigned individual about said animal by sending an email message to said email address on the tag and receiving said pre-assigned individual's contact information by return email from a database.

2. The system of claim 1, wherein the database further comprises at least the following fields:
a) owner name
b) owner address
c) owner phone number(s)—home, office, etc.
d) owner email address
e) emergency contact number(s)
f) veterinary or doctor contact number(s)
g) pet name, description
h) anonymity of owner wanted or not wanted
i) email address registered
j) reward information if applicable
k) other fields expandable as required.

3. The system of claim 2, wherein the tag further comprises a contact phone number.

4. The system of claim 3, wherein the database further comprises a logic module to provide web or phone access thereto, a user programmable algorithm for confirming the animal identity and for contacting the owner and emergency contacts in a desired manner.

5. The system of claim 4, wherein the algorithm further comprises sending reward and special notice data back to the finder of the animal.

6. An email registration system for an article comprising:
a tag which is attachable to said article;
said tag having an email address affixed thereon; and
wherein said email address is identifiable with a specific article, thereby allowing a finder to contact a pre-assigned individual about said article automatically by sending an email message to said email address on the tag and receiving said individual's contact information by return email from a database.

7. A method to identify a seeker of a lost/stolen animal, human, or article via a registered tag having a specific email address affixed thereon and assigned to said lost/stolen animal, human or article, said method comprising the steps of:
sending an email message to said specific email address on the registered tag; and
obtaining information about said seeker of said lost/stolen animal, human, or article via an email message from a central database.

8. A method of registering an animal, an individual or an article via a registration system, said method comprising the steps of:
affixing an email ID address on a tag;
providing said tag to a purchaser who places said tag on the animal, individual or article to be registered; and
registering said email ID address located on the tag by inputting data at a central service provider website into a universal database, thereby allowing a finder of the animal to send an email message to the email ID address on the tag, to automatically query said universal database for seeker and/or emergency contact information, to receive seeker and/or emergency contact information, and to contact the seeker and/or emergency contact to enable the seeker's and/or emergency contact's retrieval of said animal, individual or article.

9. The process as recited in claim 8, wherein the registration step further comprises inputting physical and/or name description of said animal, individual or article, said email address ID, owner contact information, emergency contact information, or reward information, if applicable into the universal database.

10. The process as recited in 8, wherein the registration step further comprises inputting information into a universal database having at least the following fields:
l) owner name
m) owner address
n) owner phone number(s)—home, office, etc.
o) owner email address
p) emergency contact number(s)
q) veterinary or doctor contact number(s)
r) pet name, description
s) anonymity of owner wanted or not wanted
t) email address registered
u) reward information if applicable
v) other fields expandable as required.

11. The process as recited in claim 10, wherein the step of affixing an email ID address on a tag further comprises affixing a contact phone number on said tag.

12. The process as recited in claim 11, wherein the registration step further comprises inputting data into a universal database having a logic module to provide web or phone access thereto, a user programmable algorithm for confirming the animal identity and for contacting the owner and emergency contacts in a desired manner.

13. The process as recited in claim 12, wherein the registration step further comprises programming the user programmable algorithm to send reward and special notice data back to the finder of the animal.
